(19) United States
(12) Patent Application Publication
(10) Pub. No.: US 2024/0333896 A1
(43) Pub. Date: Oct. 3, 2024

(54) IMAGE ADJUSTMENT SYSTEM, IMAGE ADJUSTMENT METHOD, AND IMAGE ADJUSTMENT DEVICE

(71) Applicant: Panasonic Intellectual Property Management Co., Ltd., Osaka (JP)

(72) Inventor: Asuka Tsuji, Nara (JP)

(21) Appl. No.: 18/741,090

(22) Filed: Jun. 12, 2024

Related U.S. Application Data
(63) Continuation of application No. PCT/JP2022/041736, filed on Nov. 9, 2022.

(30) Foreign Application Priority Data
Dec. 13, 2021 (JP) 2021-201824

(51) Int. Cl. H04N 9/31; G06T 7/73

(52) U.S. Cl. CPC H04N 9/3185; G06T 7/73

(57) ABSTRACT

An image adjustment system includes: an image projection device that projects a projected image onto a projection target; an imaging device that acquires a first image by capturing an image of a first region including a part of the projected image and a second image by capturing an image of a second region including another part of the projected image, the second region including an overlapping region in which the first region and the second region overlap; and a controller that controls a projection position of the projected image. The controller converts a first and a second coordinate systems of the first and the second images into a combined coordinate system common to the first image and the second image, generates correction information including position information indicating a projection area of the image projection device in the combined coordinate system, and generates the projected image based on the correction information.

### BACKGROUND

### 1. Technical Field

The present disclosure relates to an image adjustment system, an image adjustment method, and an image adjustment device.

### 2. Description of the Related Art

Cameras are sometimes used in correcting a video projected by a projector. When a projector projects a video across wide area, images of different sections of the projector video are captured using a plurality of cameras, and each of the captured images is corrected, e.g., by adjusting the position of the video being projected by the projector.

For example, the image projection system described in Patent Literature (PTL) 1 unifies the coordinate systems of images captured by a plurality of respective image capturing devices, and applies geometric corrections to the images projected by a plurality of respective image projection devices, using the areas where the images are projected in the unified coordinate system, as a reference.
PTL 1: PCT International Publication No. 2006/030501

### SUMMARY

The image projection system disclosed in PTL 1 still has room for improvement in terms of convenience.

The present disclosure provides an image adjustment system, an image adjustment method, and an image adjustment device with improved convenience.

An image adjustment system according to one aspect of the present disclosure includes: an image projection device that projects a projected image onto a projection target; an imaging device that acquires a first image by capturing an image of a first region including a part of the projected image and a second image by capturing an image of a second region including another part of the projected image, the second region including an overlapping region in which the first region and the second region overlap; and a controller that controls a projection position of the projected image. The controller converts a first coordinate system of the first image and a second coordinate system of the second image into a combined coordinate system common to the first image and the second image, generates correction information including position information indicating a projection area of the image projection device in the combined coordinate system, and generates the projected image based on the correction information.

An image adjustment method according to one aspect of the present disclosure includes: a step of acquiring a first image by capturing an image of a first region including a part of a projected image projected onto a projection target, and a second image by capturing an image of a second region including another part of the projected image, the second region including an overlapping region in which the first region and the second region overlap; a step of converting a first coordinate system of the first image and a second coordinate system of the second image into a combined coordinate system common to the first image and the second image; a step of generating correction information including position information indicating a projection area of the projected image in the combined coordinate system; and a step of generating the projected image based on the correction information.

An image adjustment device according to one aspect of the present disclosure is an image adjustment device that generates a projected image that is to be projected onto a projection target by an image projection device, the image adjustment device including: an image acquisition unit that acquires a first image by capturing an image of a first region including a part of the projected image and a second image by capturing an image of a second region including another part of the projected image, the second region including an overlapping region in which the first region and the second region overlap; a coordinate converter that converts a first coordinate system of the first image and a second coordinate system of the second image into a combined coordinate system common to the first image and the second image; a correction information generator that generates correction information including position information indicating a projection area of the image projection device in the combined coordinate system; and a video generator that generates the projected image based on the correction information.

According to the present disclosure, it is possible to provide an image adjustment system, an image adjustment method, and an image adjustment device with improved convenience.

### BRIEF DESCRIPTION OF THE DRAWINGS

FIG. 1 is a schematic diagram illustrating a configuration of an image adjustment system according to a first exemplary embodiment.

FIG. 2 is a block diagram illustrating the image adjustment system in FIG. 1.

FIG. 3A is a diagram illustrating an example of a first image captured by an imaging device.

FIG. 3B is a diagram illustrating an example of a second image captured by the imaging device.

FIG. 3C is a diagram illustrating an example of a third image captured by the imaging device.

FIG. 3D is a view illustrating an example of a fourth image captured by the imaging device.

FIG. 4 is a diagram illustrating a test pattern for detecting feature points.

FIG. 5 is a diagram illustrating an example in which a composite image obtained by combining the first to the fourth images is displayed on a display of a controller.

FIG. 6 is a flowchart illustrating an operation of the image adjustment system.

FIG. 7 is a diagram for explaining a modification of the first exemplary embodiment.

FIG. 8 is a schematic diagram illustrating an image adjustment system according to a second exemplary embodiment.

FIG. 9 is a flowchart illustrating the operation of the image adjustment system according to the second exemplary embodiment.

FIG. 10A is a diagram for explaining an example of a method for determining a cursor position.

FIG. 10B is a diagram for explaining an example of a method for determining a cursor position.

FIG. 10C is a diagram for explaining an example of a method for determining a cursor position.

### DETAILED DESCRIPTION

### Background to the Present Invention

Sometimes a camera is used to capture an image of a video projected by a projector, to enable adjustment of the projector video using the captured image. For example, when a video is projected on a wall or a screen installed outdoors, adjustments of a projection area where the video is projected are made by displaying a captured image on the screen of an indoor PC or the like, instead of on the actual wall or screen on site.

There is a method currently under development, for making adjustments of a video to be projected to a wide projection area. Because such a video does not fit inside of the angle of view of one camera, a plurality of cameras are used to capture images of different parts of the video, and the video is adjusted using each of such images.

In this case, because each of such images presents a part of the video, it is hard for a user to get a grasp of the entire video, so that the user has hard time making adjustments of the projector intuitively by looking at the image. In particular, in a situation in which the projector is installed outdoors and the PC or the like is installed indoors, because the actual video projected outdoors is not visually observable, it is difficult for a user to make operations intuitively, merely by being presented with captured images.

Furthermore, because the resolution of the projector is different from those of the cameras, it is difficult to calculate the pixel alignment between the cameras and the projector, accurately.

To address these issues, the inventor(s) of the present invention has sought for an image adjustment system allowing users to perform operations intuitively, and have come up with the following invention.

An image adjustment system according to a first aspect of the present disclosure includes: a image projection device that projects a projected image to be projected onto a projection target; an imaging device that acquires a first image by capturing an image of a first region including at least a part of the projected image and a second image by capturing an image of a second region including at least a part of the projected image and including a region overlapping with the first region; and a controller that controls a projection position of the projected image, in which the controller is configured to: convert a first coordinate system of the first image and a second coordinate system of the second image into a combined coordinate system common to the first image and the second image; generate correction information including position information indicating a projection area of the image projection device in the combined coordinate system; and generate the projected image based on the correction information.

With such a configuration, an image adjustment system with improved convenience can be provided.

In the image adjustment system according to a second aspect of the present disclosure, the controller may correct the projected image by converting coordinates indicating the position information in the combined coordinate system into the first coordinate system and the second coordinate system, and further converting the first coordinate system and the second coordinate system into a projector coordinate system of the image projection device.

With such a configuration, it is possible to provide an image adjustment system that achieves a highly accurate alignment of the projection areas, with improved convenience.

In the image adjustment system according to the third aspect of the present disclosure, the controller may generate a composite image of the first image and the second image based on an overlapping portion between the first region of the first image and the second region of the second image, and the combined coordinate system may be used to indicate coordinates in the composite image.

With such a configuration, users can make corrections while getting a grasp of the entire video on the composite image.

In the image adjustment system according to the fourth aspect of the present disclosure, the controller may superimpose an adjustment image indicating the projection area, over the composite image.

With such a configuration, users can make corrections while getting a grasp of the entire video on the composite image.

In an image adjustment system according to a fifth aspect of the present disclosure, the image projection device may project an adjustment image indicating the projection area, onto the projection target.

Because the projection area is adjusted using the image projected by the image projection device, it is possible to reduce a positional deviation caused by the difference in the resolutions of the image projection device and the imaging device.

In the image adjustment system according to a sixth aspect of the present disclosure, the controller may determine the projection area based on the first image and the second image.

With such a configuration, because the projection area can be adjusted without any user operation, convenience is improved.

An image adjustment method according to a seventh aspect of the present disclosure includes: a step of acquiring a first image by capturing an image of a first region of a projected image projected onto a projection target, and a second image by capturing a second region including at least a part of the projected image and including a region overlapping with the first region; a step of converting a first coordinate system of the first image and a second coordinate system of the second image into a combined coordinate system common to the first image and the second image; a step of generating correction information including position information indicating a projection area of the projected image in the combined coordinate system; and a step of generating the projected image based on the correction information.

With such a configuration, an image adjustment method with improved convenience can be provided.

In an image adjustment method according to an eighth aspect of the present disclosure, the step of generating the correction information including the position information indicating the projection area of the projected image in the combined coordinate system may include: converting coordinates indicating the position information in the combined coordinate system into the first coordinate system and the second coordinate system; and further converting the first coordinate system and the second coordinate system into a coordinate system of an image projection device that projects the projected image.

With such a configuration, it is possible to provide the image adjustment method that achieves a highly accurate alignment of the projection areas, with improved convenience.

In the image adjustment method according to a ninth aspect of the present disclosure, the step of converting the first coordinate system and the second coordinate system into the combined coordinate system common to the first image and the second image may include generating a composite image of the first image and the second image based on an overlapping portion between the first region of the first image and the second region of the second image.

With such a configuration, users can make corrections while getting a grasp of the entire video on the composite image.

An image adjustment device according to a tenth aspect of the present disclosure is an image adjustment device that generates a projected image projected onto a projection target by an image projection device, the image adjustment device including: an image acquisition unit that acquires a first image by capturing an image of a first region of the projected image and a second image by capturing an image of a second region including at least a part of the projected image and including a region overlapping with the first region; a coordinate converter that converts a first coordinate system of the first image and a second coordinate system of the second image into a combined coordinate system common to the first image and the second image; a correction information generator that generates correction information including position information indicating a projection area of the image projection device in the combined coordinate system; and a video generator that generates the projected image based on the correction information.

With such a configuration, an image adjustment device with improved convenience can be provided.

In the image adjustment device according to an eleventh aspect of the present disclosure, the correction information generator may generate the correction information by converting coordinates indicating the position information in the combined coordinate system into the first coordinate system and the second coordinate system, and further converting the first coordinate system and the second coordinate system into a projector coordinate system of the image projection device.

With such a configuration, it is possible to provide the image adjustment device that achieves a highly accurate alignment of the projection areas, with improved convenience.

In the image adjustment device according to a twelfth aspect of the present disclosure, the video generator may generate a composite image of the first image and the second image based on an overlapping portion between the first region of the first image and the second region of the second image.

With such a configuration, users can make corrections while getting a grasp of the entire video on the composite image.

Some exemplary embodiments will now be described in detail with reference to the drawings, as appropriate. However, descriptions more in detail than necessary may be omitted. For example, detailed descriptions of already well-known matters and redundant descriptions of substantially identical configurations may be omitted. This is to avoid unnecessarily redundancy in the following description and to facilitate understanding of those skilled in the art.

The inventor provides the accompanying drawings and the following description to help those skilled in the art to fully understand the present disclosure, but these drawings and the description are not intended to limit subject matters recited in the claims in any way.

### First Exemplary Embodiment

### [Overall Configuration]

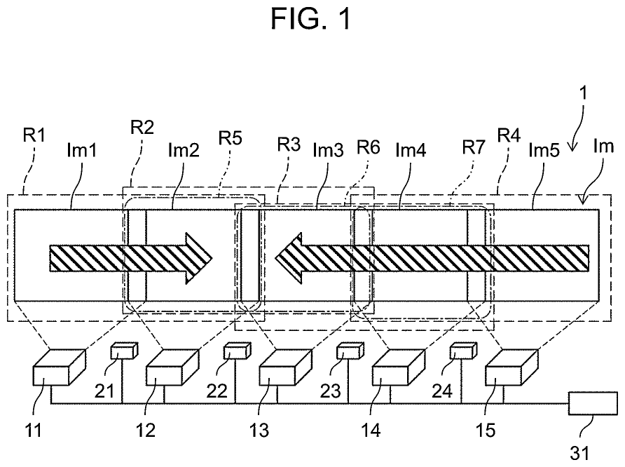

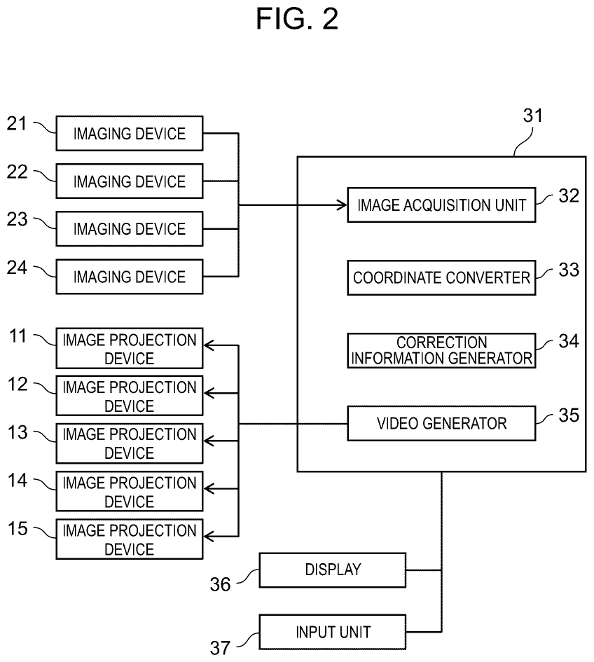

FIG. 1 is a schematic diagram illustrating image adjustment system 1 according to a first exemplary embodiment. FIG. 2 is a block diagram illustrating image adjustment system 1 in FIG. 1. To begin with, image adjustment system 1 will be described with reference to FIGS. 1 and 2.

Image adjustment system 1 includes image projection devices 11 to 15, imaging devices 21 to 24, and controller 31.

Each of the image projection devices 11 to 15 is a device that projects a video generated on the basis of the input video signals, through a projection lens. Image projection devices 11 to 15 can transmit and receive data or information such as the video signals to and from controller 31, which will be described later. Each of image projection devices 11 to 15 generates a video on the basis of the video signals input from controller 31, and outputs projection light (for example, visible light) to be projected onto a projection target such as a screen or a wall.

In the present exemplary embodiment, as illustrated in FIG. 1, one video Im is projected by five image projection devices 11 to 15. Specifically, image projection devices 11 to 15 are lined up in the lateral direction, and each of image projection devices 11 to 15 projects a different part of video Im. Image projection device 11 projects video Im1 that is a part of video Im. Image projection device 12 projects video Im2 that is a part of video Im. Image projection device 13 projects video Im3 that is a part of video Im. Image projection device 14 projects video Im4 that is a part of video Im. Image projection device 15 projects video Im5 that is a part of video Im. Image projection devices 11 to 15 projects respective videos Im1 to Im5 onto the projection target simultaneously, so that one video Im is formed on the projection target.

In the present exemplary embodiment, image projection devices 11 to 15 are arranged in such a manner that the adjacent videos, for example, video Im1 and video Im2, overlap each other, although the adjacent videos do not necessarily need to overlap each other.

Each of imaging devices 21 to 24 captures an image of a region including at least a part of projected image Im. Imaging device 21 captures an image of first region R1 including video Im1 and video Im2. Imaging device 22 captures an image of second region R2 including video Im2 and video Im3. Imaging device 23 captures an image of third region R3 including video Im3 and video Im4. Imaging device 24 captures an image of fourth region R4 including video Im4 and video Im5. First region R1 includes at least a part of video Im. Second region R2 includes at least a part of video Im, and includes region R5 (overlapping region) overlapping with first region R1. Similarly, third region R3 includes at least a part of video Im, and includes region R6 overlapping with second region R2. Further, fourth region R4 includes at least a part of video Im, and includes region R7 overlapping with third region R3.

Controller 31 controls image projection devices 11 to 15 and imaging devices 21 to 24 to control the position where video Im is projected. In the present exemplary embodiment, controller 31 includes image acquisition unit 32, coordinate converter 33, correction information generator 34, and video generator 35.

Controller 31 includes a general-purpose processor such as a CPU or an MPU that implements a predetermined function by executing a program. Controller 31 also includes a storage unit, not illustrated. Controller 31 implements the functions of image acquisition unit 32, coordinate converter 33, correction information generator 34, and video generator 35 by calling and executing a control program stored in a storage, not illustrated. Controller 31 may also be a hardware circuit designed exclusively for the purpose of implementing a predetermined function, without limitation to the configuration implementing a predetermined function through the cooperation of hardware and software. That is, controller 31 may be implemented as a processor of various types, such as a CPU, an MPU, a GPU, an FPGA, a DSP, and an ASIC.

Furthermore, to controller 31, display 36 such as a liquid crystal display, or input unit 37 such as a keyboard and a mouse may be connected, as illustrated in FIG. 2. Controller 31 may also include display 36 or input unit 37. In such a configuration, it is possible to present the image acquired by imaging devices 21 to 24 onto display 36 to allow the user to check the image.

Controller 31 may be incorporated in an image adjustment device such as a PC. The image adjustment device including controller 31 may be connected to image projection devices 11 to 15 and imaging devices 21 to 24 over a wireless or wired network, for example. Alternatively, some of the functions of controller 31 may be incorporated in image projection devices 11 to 15.

Note that controller 31 corresponds to the “image adjustment device” according to the present disclosure.

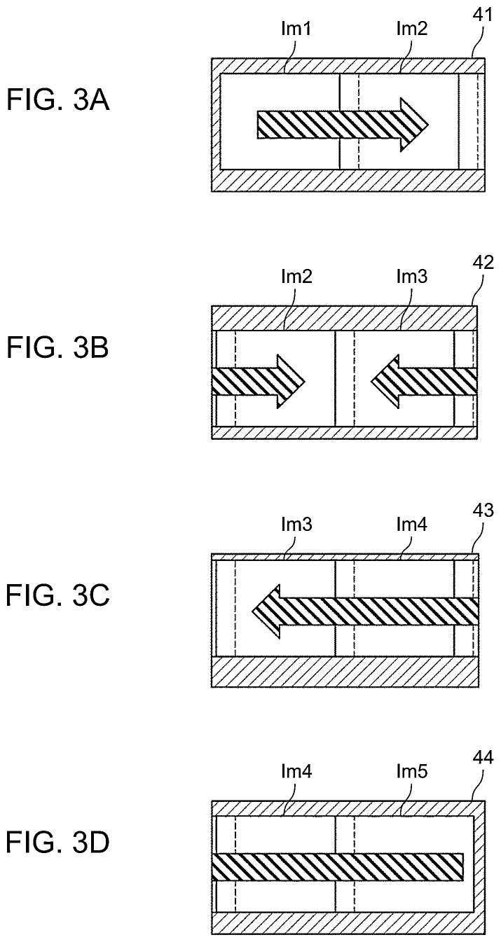

Image acquisition unit 32 controls imaging devices 21 to 24 to acquire first to fourth images 41 to 44 of video Im. FIGS. 3A to 3D are diagrams illustrating examples of first to fourth images 41 to 44 captured by the imaging devices. For example, image acquisition unit 32 acquires first image 41 that is an image of first region R1 (see FIG. 1) including video Im1 and video Im2, captured by imaging device 21. Similarly, image acquisition unit 32 acquires second image 42 (FIG. 3B) that is an image of second region R2 captured by imaging device 22, third image 43 (FIG. 3C) that is an image of third region R3 captured by imaging device 23, and fourth image 44 (FIG. 3D) that is an image of fourth region R4 captured by imaging device 24.

Coordinate converter 33 converts the first coordinate system of first image 41, the second coordinate system of second image 42, the third coordinate system of third image 43, and the fourth coordinate system of fourth image 44 into a combined coordinate system common to all of the first to fourth coordinate systems.

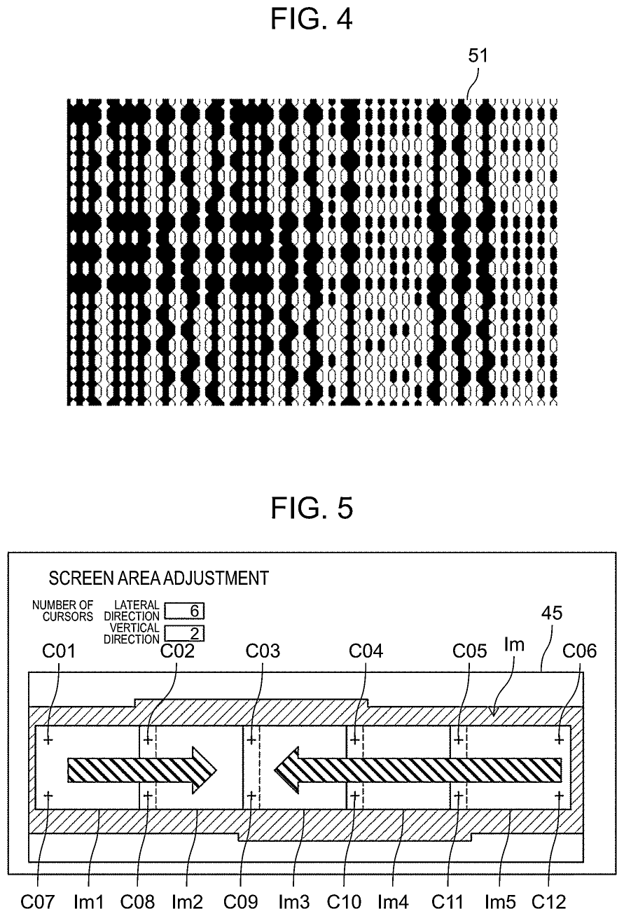

FIG. 4 is a diagram illustrating test pattern 51 for detecting feature points. Test pattern 51 illustrated in FIG. 4 is projected onto a projection target by each of image projection devices 11 to 15. First to fourth images 41 to 44 including test pattern 51 are captured by imaging devices 21 to 24, respectively. On the basis of first to fourth images 41 to 44 obtained by capturing images of test pattern 51, coordinate converter 33 is allowed to generate a combined coordinate system. Note that the test pattern is not limited to that illustrated in FIG. 4, and may be any pattern as long as a combined coordinate system can be generated.

Specifically, coordinate converter 33 detects a plurality of feature points included in test patterns 51 in each pair of images 41 to 44 captured by adjacent pairs of corresponding imaging devices 21 to 24, and obtains coordinates of the feature points in the respective coordinate systems (the first to the fourth coordinate systems). For example, first image 41 and second image 42 both include overlapping region R5 with the same feature points projected by the same image projection device 12. Coordinate converter 33 therefore calculates a coordinate conversion formula for converting the coordinates of the feature points in the first coordinate system and the coordinates of the same feature points in the second coordinate system into coordinates in a common coordinate system shared between the first coordinate system and the second coordinate system. In calculating the coordinate conversion formula, for example, coordinate converter 33 may use a method of obtaining a planar projective transformation matrix, using four or more sets of corresponding relationships between the coordinates of the same feature points in the first coordinate system and in the second coordinate system, the feature points being projected by the same image projection device.

For remaining images 42 to 44, too, coordinate converter 33 calculates a coordinate conversion formula for converting the second to fourth coordinate systems into the common coordinate system in the same manner, by detecting the same feature points included in the overlapping regions R6 to R7 of the respective images. Using these coordinate conversion formulas for converting the coordinates of the first to fourth coordinate systems into those of the combined coordinate system, coordinate converter 33 is enabled to perform coordinate conversions from the coordinates in each of the first to fourth coordinate systems into those the combined coordinate system.

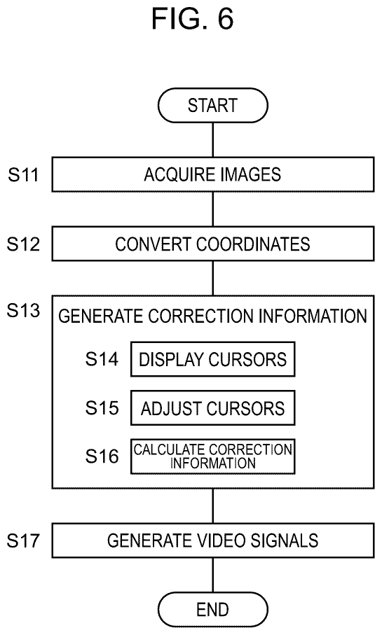

FIG. 5 is a diagram illustrating an example in which composite image 45 resultant of combining first to fourth images 41 to 44 is displayed on display 36 of controller 31. Controller 31 may generate composite image 45 of first to fourth images 41 to 44 using the coordinate conversion formulas described above, and display composite image 45 on display 36, as illustrated in FIG. 5. On composite image 45 displayed on display 36, a user can designate a projection area to be projected by each of the image projection devices 11 to 15.

For example, as illustrated in FIG. 5, controller 31 may display adjustment images C01 to C12 on composite image 45 indicating projection areas of respective image projection devices 11 to 15. Adjustment images C01 to C12 are, for example, images indicating the four corners of each of the projection areas projected by respective image projection devices 11 to 15, and a cross cursor may be used for each of adjustment images C01 to C12, as illustrated in FIG. 5. Hereinafter, adjustment images C01 to C12 are sometimes referred to as cursors C01 to C12, respectively. In the present exemplary embodiment, controller 31 determines the number of cursors C01 to C12 in accordance with the number of videos Im1 to Im5 (the number of image projection devices 11 to 15). Specifically, because the number of videos Im1 to Im5 is 5, controller 31 determines the number of cursors C01 to C12 as 12 (=5×2+2). Controller 31 generates 12 cursors C01 to C12 and superimposes cursors C01 to C12 on composite image 45. The number of cursors may be greater or smaller than the number determined in the method described above, or the user may change the number of cursors to any number.

In the present exemplary embodiment, as illustrated in FIG. 5, cursors C01, C02, C07, C08 indicate the four corners of video Im1 projected by image projection device 11. The user can designate the projection area for video Im1 to any area, by moving cursors C01, C02, C07, and C08 using an input unit (not illustrated) of controller 31. In the same manner, the user can designate the projection areas for videos Im2 to Im5 to any areas, respectively.

Correction information generator 34 generates correction information including position information indicating the projection areas to be projected by respective image projection devices, in the combined coordinate system. The correction information is information including the coordinates obtained by converting the position information indicating the projection areas in the combined coordinate system into the projector coordinate systems of respective image projection devices 11 to 15. The projection area for each of the image projection devices is designated by the user, using the coordinates of the combined coordinate system in composite image 45. The projection areas are indicated by, for example, the coordinates indicating the positions of cursors C01 to C12 illustrated in FIG. 5, in the combined coordinate system. Correction information generator 34 then converts the coordinates indicating the projection areas in the combined coordinate system into the coordinates in the first to the fourth coordinate systems, respectively, using the respective coordinate conversion formulas calculated by coordinate converter 33. Correction information generator 34 also obtains a coordinate conversion table for converting the first to the fourth coordinate systems into the projector coordinate systems of respective image projection devices 11 to 15, from the corresponding relationships between the first to the fourth coordinate systems and the projector coordinate systems of image projection devices 11 to 15, respectively.

On the basis of this coordinate conversion table, correction information generator 34 converts the coordinates of the projection area in each of the first to the fourth coordinate systems into the corresponding coordinates in the projector coordinate system of corresponding one of image projection devices 11 to 15. The correction information generated by correction information generator 34 includes the coordinates of the projection area, in the projector coordinate systems of image projection devices 11 to 15, respectively.

Video generator 35 generates video signals of videos Im1 to Im5 to be projected by respective image projection devices 11 to 15, on the basis of the correction information generated by correction information generator 34. Specifically, video generator 35 generates video signals resultant of correcting the projection areas of the respective videos on the basis of the coordinates of the projection areas included in the correction information.

### [Operation]

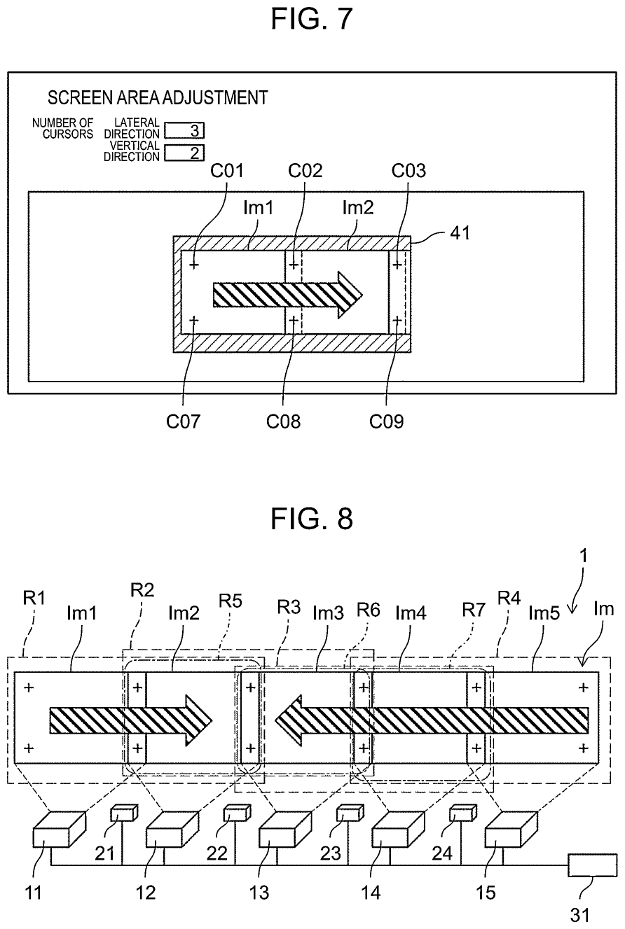

An operation of image adjustment system 1 having the configuration described above will now be described with reference to FIG. 6. FIG. 6 is a flowchart illustrating an operation of image adjustment system 1.

Image acquisition unit 32 acquires first to fourth images 41 to 44 captured by imaging devices 21 to 24, respectively (step S11). Image acquisition unit 32 acquires two types of images: images resultant of capturing an image of test pattern 51 for the feature point detection, using imaging devices 21 to 24, respectively; and first to fourth images 41 to 44 resultant of capturing an image of the adjustment image using imaging devices 21 to 24, respectively. Images 41 to 44 obtained by capturing images of the adjustment image are images for allowing the user to designate the projection areas in subsequent step S13. As the adjustment image, for example, a flat white video may be used, as illustrated in FIGS. 3A to 3D. Alternatively, the adjustment image may also be a frame line surrounding the projection area for the corresponding image projection device 11 to 15.

Coordinate converter 33 then converts the first to the fourth coordinate systems into the common combined coordinate system (step S12). Coordinate converter 33 can convert the coordinate systems by calculating the coordinate conversion formulas on the basis of images of test pattern 51 for the feature point detection, captured by respective imaging devices 21 to 24. Coordinate converter 33 also generates composite image 45 of first to fourth images 41 to 44, on the basis of the coordinate conversion formulas. Note that the coordinate conversion formulas may be calculated in advance. In such a case, the coordinate conversion formulas may be stored in the storage unit of controller 31.

Correction information generator 34 generates correction information (step S13). Controller 31 displays composite image 45 on display 36, and displays cursors C01 to C12 for designating projection areas on composite image 45 (step S14). The user then moves cursors C01 to C12 to designate projection areas for respective image projection devices 11 to 15 (step S15). Correction information generator 34 then calculates the coordinates of cursors C01 to C12 in the corresponding projector coordinate systems, on the basis of the coordinates of cursors C01 to C12 indicating the projection areas designated by the user in the combined coordinate system, and generates the correction information (step S16).

Lastly, video generator 35 generates video signals on the basis of the correction information (step S17).

### [Effects]

According to the exemplary embodiment described above, it is possible to provide an image adjustment system, an image adjustment method, and an image adjustment device with improved convenience.

Because the projection areas can be designated using composite image 45 obtained by combining first to fourth images 41 to 44 captured by respective imaging devices 21 to 24, the user can designate the projection areas for respective image projection devices 11 to 15 while getting a grasp of entire video Im.

Described above in the exemplary embodiment is an example in which image adjustment system 1 includes five image projection devices 11 to 15, but the present invention is not limited thereto. The number of image projection devices included in image adjustment system 1 may be any number that is one or more.

Described above in the exemplary embodiment is an example in which image projection devices 11 to 15 are lined up in one lateral row, but the present invention is not limited thereto. For example, image projection devices 11 to 15 may be disposed at any positions in a manner suitable for the size of the video to be projected, e.g., along a vertical line or along two or more lines.

Described above in the exemplary embodiment is an example in which image adjustment system 1 includes four imaging devices 21 to 24, but the present invention is not limited thereto. The number of imaging devices included in image adjustment system 1 may be any number that is two or more.

Described above in the exemplary embodiment is an example in which the imaging devices 21 to 24 are lined up in one lateral row, but the present invention is not limited thereto. For example, imaging devices 21 to 24 may be arranged in any positions in a manner suitable for the video to be projected, e.g., arranged in a horizontal row or in two or more rows.

Described above in the exemplary embodiment is an example in which there is overlapping region R5 where first region R1 and second region R2 overlap each other, but the present invention is not limited thereto. For example, adjacent imaging devices may capture images of any regions at least including a part of the same video, among videos Im1 to Im5. In other words, adjacent imaging devices may capture images of any region at least including a part of the video output from the same image projection device.

Furthermore, described above in the exemplary embodiment is an example in which the combined coordinate system is generated using the images of test pattern 51 captured by imaging devices 21 to 24, but the present invention is not limited thereto. For example, the same video may be projected by the same image projection device across the areas where the plurality of imaging devices capture the respective images, e.g., across regions R5 to R7. It is also possible for the video not to be projected across the areas where the plurality of imaging devices capture the respective images. In such a case, it is possible to generate the combined coordinate system without capturing any images of test pattern 51.

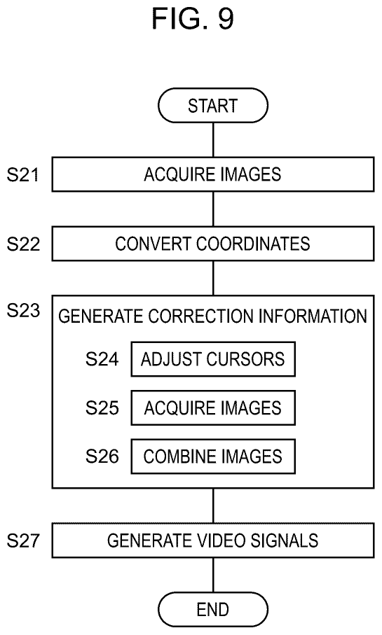

FIG. 7 is a diagram for explaining a modification of the first exemplary embodiment. For example, it is also possible to permit a user to make rough adjustment of the projection areas while getting a general grasp of entire video Im, by displaying cursors C01 to C12 on composite image 45 illustrated in FIG. 5, and then to make fine adjustments of the projection areas in first to fourth images 41 to 44, respectively. After the user has roughly adjusted the projection areas on composite image 45, the image on display 36 may be switched to first image 41, as illustrated in FIG. 7, so that the user can finely adjust the positions of cursors C01 to C03 and C07 to C09.

In such a case, coordinate converter 33 converts the coordinates of the positions of cursors C01 to C12 having been changed on composite image 45 into the coordinates of the respective coordinate systems of first to fourth images 41 to 44, and display cursors C01 to C12 on corresponding images 41 to 44. Correction information generator 34 then converts the coordinates of the positions of cursors C01 to C12 having been changed on images 41 to 44 into the projector coordinate systems of respective image projection devices 11 to 15.

With such a configuration, composite image 45 may be used for getting a grasp of entire video Im, and the projection areas may be adjusted more finely using each of images 41 to 44. Therefore, it is possible to adjust the projection areas highly accurately.

It is also possible for controller 31 to determine the projection areas based on first to fourth images 41 to 44. For example, the size, the position, and the like of a projection target, such as a screen, are estimated from each of first to fourth images 41 to 44. Controller 31 then determines the size and the position of the projection areas based on the estimated size and position of the projection target. Controller 31 may also display cursors C01 to C12 in composite image 45 on the basis of the estimated projection areas. Controller 31 may also determine an appropriate number of cursors and appropriate positions to display the cursors on the basis of the estimated size and position of the projection target, or on the basis of the number of image projection devices and imaging devices. Controller 31 may also make the estimations of the projection areas on the basis of composite image 45.

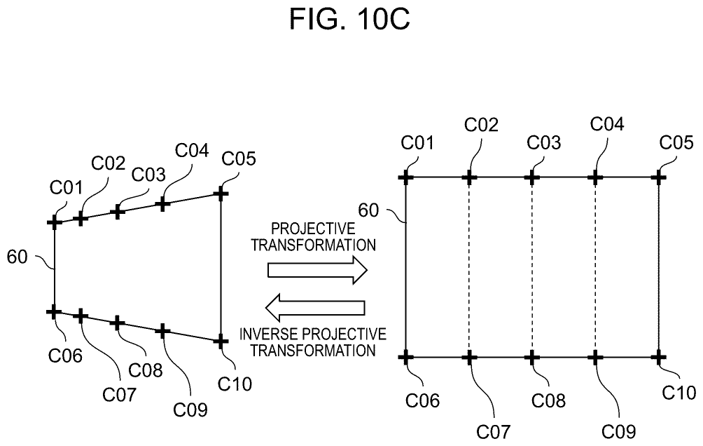

An example of a method of determining the positions at which the cursors are to be displayed in composite image 45 will now be described with reference to FIGS. 10A to 10C. In the exemplary embodiment described above, image projection devices 11 to 15 and imaging devices 21 to 24 are arranged along a line, as illustrated in FIG. 1. However, in this one example, as illustrated in FIG. 10A, imaging device 20 is disposed obliquely with respect to image projection device 10 that projects a video onto screen 60 (projection target). In this example, although not illustrated in detail, image projection device 10 includes four image projection devices, and imaging device 20 includes three imaging devices. That is, in this example, four projected images are projected by four respective image projection devices onto screen 60. Image projection device 10 may be a single device including a shared light source, and projecting four projected images onto screen 60, simultaneously.

As illustrated in FIG. 10A, in the arrangement in which imaging device 20 is oblique with respect to the screen 60, the composite image generated by controller 31 is displayed in a trapezoidal shape on display 36, as illustrated on the left side of FIG. 10B. If the positions of cursors C01 to C10 are determined at equal intervals in the lateral direction with respect to the composite image on display 36, cursors C01 to C10 are plotted as indicated on the left side in FIG. 10B. However, once the coordinates of cursors C01 to C10 in the combined coordinate system are converted into the coordinates of the projector coordinate systems, cursors C01 to C10 ends up being plotted as illustrated on the right side in FIG. 10B on the screen 60, in a view directly from the front side. Consequently, on the screen, the cursors are not positioned at equal intervals, and correction of the video may end up causing a distortion in the video projected by image projection device 10.

Therefore, in this one example, as illustrated in FIG. 10C, the inclination of imaging device 20 with respect to the screen 60 is taken into consideration in the assignment of cursors C01 to C10 to the composite image. Specifically, controller 31 detects the shape of the screen 60 by recognizing the four corners of the screen 60 in the composite image using an image recognition technique. At this time, in this example, it is assumed that the projected image is projected on screen 60 substantially in the same size as screen 60. The coordinates of the four corners in the combined coordinate system are then subjected to projective transformation into a quadrangle (square or rectangle). Cursors C01 to C10 are then plotted to the quadrangle obtained by the projective transformation at equal intervals along the lateral direction (the right side in FIG. 10C), thereby establishing the tentative positions of cursors C01 to C10. The positions of cursors C01 to C10 in the composite image are then determined by then subjecting the coordinates (tentative positions) of cursors C01 to C10 having been plotted at equal intervals to the inverse projective transformation into the coordinates in the combined coordinate system.

By making corrections using the cursors at the positions determined in the manner described above, the distortion in the video projected by image projection device 10 can be reduced.

In generating the correction information, correction information generator 34 may use the projection areas determined by controller 31, instead of the projection areas designated by the user, as in the exemplary embodiment described above. The user may also be enabled to further adjust the projection areas determined by controller 31.

Furthermore, in one example, controller 31 may cause display 36 to display a video that is based on the correction information, as composite image 45. Specifically, after step S17 in FIG. 6, image projection devices 11 to 15 receive the video signals generated on the basis of the correction information from controller 31. Image projection devices 11 to 15 then project corrected video Im (videos Im1 to Im5) onto a projection target based on the received video signals. Imaging devices 21 to 24 then capture images of corrected video Im projected onto the projection target, as first to fourth images 41 to 44, respectively. Controller 31 then acquires first to fourth images 41 to 44 from imaging devices 21 to 24, respectively, and generates composite image 45 based on first to fourth images 41 to 44. Controller 31 then causes display 36 to display generated composite image 45. Consequently, the user can check the entire image of corrected video Im being projected onto the projection target, on display 36, without looking at the projection target (screen).

### Second Exemplary Embodiment

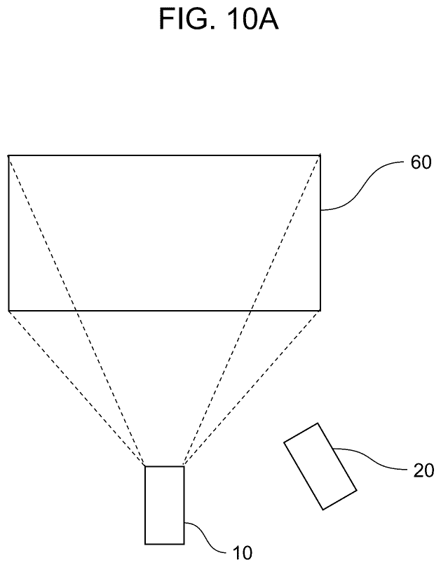

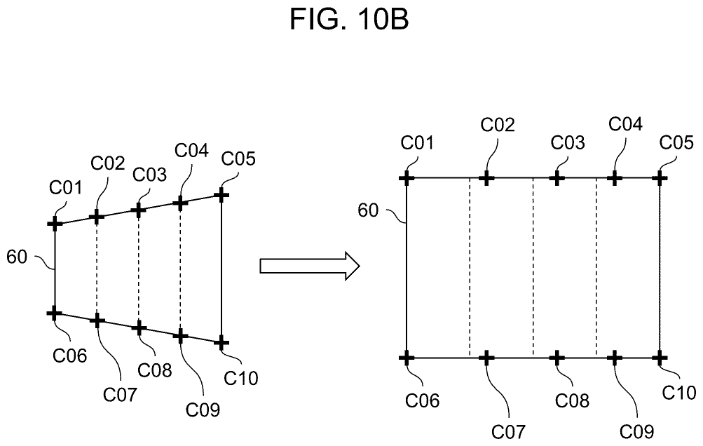

A second exemplary embodiment will now be described with reference to FIGS. 8 and 9. In the second exemplary embodiment, components that are identical or equivalent to those in the first exemplary embodiment are denoted by the same reference marks as those in the first exemplary embodiment. The description already given for the first exemplary embodiment is omitted for the second exemplary embodiment.

FIG. 8 is a schematic diagram illustrating image adjustment system 1 according to a second exemplary embodiment. The second exemplary embodiment is different from the first exemplary embodiment in that image projection devices 11 to 15 project an adjustment image indicating a projection area onto a projection target, as illustrated in FIG. 8. Components of image adjustment system 1 are the same as those in the first exemplary embodiment.

FIG. 9 is a flowchart illustrating the operation of image adjustment system 1 according to the second exemplary embodiment. An operation of image adjustment system 1 according to the second exemplary embodiment will now be described with reference to FIG. 9. Note that steps S21, S22, and S27 are the same as steps S11, S12, and S17, respectively, in the first exemplary embodiment described with reference to FIG. 4, and therefore description thereof is omitted.

Once coordinate converter 33 converts the first to the fourth coordinate systems into a common combined coordinate system (step S22), correction information generator 34 generates correction information (step S23). In the present exemplary embodiment, because adjustment images (cursors) C01 to C12 have been projected by corresponding image projection devices 11 to 15, cursors C01 to C12 are included in the composite image generated in step S22. Therefore, the user designates the projection areas by adjusting the positions of cursors C01 to C12 while looking at the composite image displayed on display 36 (step S24).

Imaging devices 21 to 24 then captures images of videos Im1 to Im5 including cursors C01 to C12 having their positions adjusted, to acquire first to fourth images 41 to 44 again (step S25). Controller 31 then generates a composite image of the captured image 41 to 44, and displays the composite image on display 36 (step S26).

By repeating steps S24 to S26, it is possible to match the positions of cursors C01 to C12 projected by image projection devices 11 to 15 to the positions of the cursors on the composite image.

In the present exemplary embodiment, because the user moves cursors C01 to C12 projected by image projection devices 11 to 15, it is possible to generate the correction information without the coordinate conversion of the combined coordinate system into the projector coordinate systems in step S23 for generating the correction information. Therefore, for example, even when image projection devices 11 to 15 have different resolutions from those of imaging devices 21 to 24 and therefore the pixel alignment is less accurate, it is possible to adjust the projection areas highly accurately.

Note that steps S25 to S26 may be performed at predetermined timings, or may be executed after the user adjusts the cursors in step S24.

### Third Exemplary Embodiment

In the present exemplary embodiment, an aspect combining the first exemplary embodiment and the second exemplary embodiment will be described.

In the aspect explained in the first exemplary embodiment, videos Im1 to Im5 projected by respective image projection devices 11 to 15 are corrected by moving the positions of the cursors on composite image 45 displayed on display 36. In this aspect, because the cursor positions are moved on composite image 45, the cursor positions can be adjusted in a timely manner. Therefore, it is possible to move the positions of the cursors in a timely manner, in response to a user's operation for moving the cursor on input unit 37 (such as a keyboard or a mouse). At the same time, there may be an error between a position the user designates on composite image 45 and the position corresponding thereto in video Im actually projected onto the projection target. This is because the image projection devices and the imaging devices have different resolutions, the conversion into the projector coordinate systems may cause a deterioration in the accuracy of the pixel alignment.

In the aspect described in the second exemplary embodiment, videos Im1 to Im5 projected by respective image projection devices 11 to 15 are corrected by moving the positions of the cursors projected on the projection target. According to this aspect, because the cursors are moved in the projector coordinate system, the video Im can be corrected highly accurately. At the same time, every time the positions of the cursors are moved, it is necessary to perform the process of capturing images of video Im using imaging devices 21 to 24, respectively, and of combining resultant first to fourth images 41 to 44 including video Im. Therefore, after the user performs the operation for moving the cursor positions, an extensive delay may be introduced until the composite image reflecting the changed cursor positions is displayed.

On the basis of the above, by performing a rough adjustment of the cursor positions as in the aspect according to the first exemplary embodiment, and performing a fine adjustment of the cursor positions as in the aspect of the second exemplary embodiment, it becomes possible to adjust the cursor positions highly accurately, in a shorter time period, as a whole. With this, it becomes possible to shorten the time required for the adjustment, as well as to improve the precision of the adjustment.

### Fourth Exemplary Embodiment—1

In the present exemplary embodiment, a method for giving a recommendation to the user as to which one of the aspect according to the first exemplary embodiment or that according to the second exemplary embodiment is better to use will be described.

In the present exemplary embodiment, controller 31 recommends the user which aspect to use, on the basis of the number of imaging devices that are connected to controller 31. Specifically, controller 31 determines the number of imaging devices, and, if the determined number of imaging devices is three or less, controller 31 recommends the user to use the aspect according to the second exemplary embodiment. At this time, controller 31 may cause display 36 to display a message recommending the user to adjust the cursor positions using the method corresponding to the aspect according to the second exemplary embodiment. If the number of imaging devices determined by controller 31 is four or more, controller 31 recommends the user to use the aspect according to the first exemplary embodiment. At this time, controller 31 may cause display 36 to display a message recommending the user to adjust the cursor positions using the method corresponding to the aspect according to the first exemplary embodiment.

The aspect according to the first exemplary embodiment is recommended when the number of imaging devices is four or more because, in the aspect according to the second exemplary embodiment, when the number of imaging devices increases, the processing time for generating the composite image becomes extended; and therefore, the movements of the cursor positions are delayed with respect to the user operations.

Because the time required for generating the composite image also depends on the specification of the machine, it is also possible to set a threshold (the number of imaging devices) in accordance with the specifications of machine.

### Fourth Exemplary Embodiment—2

In the present exemplary embodiment, another method for giving a recommendation to the user as to which one of the aspect according to the first exemplary embodiment or that according to the second exemplary embodiment is better to use will be described.

In the present exemplary embodiment, controller 31 recommends a user which aspect to use, in accordance with the ratio of a projected image projected by the image projection device in a captured image captured by the imaging device. Specifically, controller 31 acquires a captured image captured by an imaging device from the imaging device. Controller 31 then recognizes the size occupied by the projected image projected by the image projection device with respect to the captured image, using an image recognition technique. Controller 31 then calculates the ratio of the area occupied by the projected image with respect to the area of the captured image. Controller 31 then determines which one of the aspects is better to use, based on the calculated area ratio, the resolution of the imaging device, and the resolution of the image projection device. For example, when the resolution of the imaging device is 4000×3000 and the resolution of the image projection device is 1920×1200, the ratio of the resolution of the image projection device with respect to the resolution of the imaging device is 19.2% (=1920×1200/4000×3000). Under an assumption that the cursor in the projected image is rendered with a line having the width of one pixel, if the calculated ratio of the area occupied by the projected image with respect to the area of the captured image is less than 19.2%, the aspect according to the first exemplary embodiment is recommended to the user.

The reason why the aspect according to the first exemplary embodiment is recommended when the ratio of the area of the projected image is low is that, when the ratio of the area occupied by the projected image is lower than the ratio of the resolution, the cursor in the captured image of the imaging device becomes smaller than one pixel, and it becomes difficult for the imaging device to capture the cursor in the image.

The present disclosure is applicable to displaying of a video using an image projection device.

What is claimed is:

1. An image adjustment system comprising:
an image projection device that projects a projected image onto a projection target;
an imaging device that acquires a first image by capturing an image of a first region including a part of the projected image and a second image by capturing an image of a second region including another part of the projected image, the second region including an overlapping region in which the first region and the second region overlap; and
a controller that controls a projection position of the projected image, wherein
the controller is configured to:
convert a first coordinate system of the first image and a second coordinate system of the second image into a combined coordinate system common to the first image and the second image;
generate correction information including position information indicating a projection area of the image projection device in the combined coordinate system; and
generate the projected image based on the correction information.

2. The image adjustment system according to claim 1, wherein the controller generates the projected image by converting coordinates indicating the position information in the combined coordinate system into coordinates in the first coordinate system and the second coordinate system, and further converting the coordinates in the first coordinate system and the second coordinate system into coordinates into a projector coordinate system of the image projection device.

3. The image adjustment system according to claim 1, wherein
the controller generates a composite image of the first image and the second image, based on the overlapping region, and
the composite image have coordinates indicated by the combined coordinate system.

4. The image adjustment system according to claim 3, wherein the controller superimposes an adjustment image indicating the projection area, over the composite image.

5. The image adjustment system according to claim 4, wherein a plurality of the image projection devices project a plurality of the projected images onto the projection target, respectively, and
the controller is configured to:
generate a plurality of the adjustment images corresponding to number of the plurality of projected images; and
superimpose the plurality of adjustment images over the composite image.

6. The image adjustment system according to claim 5, wherein the controller is configured to:
detect a shape of the projection target in the composite image;
superimpose the plurality of adjustment images over the composite image based on the detected shape of the projection target.

7. The image adjustment system according to claim 6, wherein the controller is configured to:
perform a projective transformation of the detected shape of the projection target;
determine tentative positions of the plurality of adjustment images based on a shape resultant of the projective transformation;
determine positions of the plurality of adjustment images in the composite image by performing inverse projective transformation of the tentative positions of the plurality of adjustment images; and
superimpose the plurality of adjustment images over the composite image based on the positions of the plurality of adjustment images in the composite image.

8. The image adjustment system according to claim 1, wherein the image projection device is configured to further project an adjustment image indicating the projection area onto the projection target.

9. The image adjustment system according to claim 1, wherein the controller is configured to determine the projection area based on the first image and the second image.

10. An image adjustment method comprising:
a step of acquiring a first image by capturing an image of a first region including a part of a projected image projected onto a projection target, and a second image by capturing an image of a second region including another part of the projected image, the second region including an overlapping region in which the first region and the second region overlap;
a step of converting a first coordinate system of the first image and a second coordinate system of the second image into a combined coordinate system common to the first image and the second image;
a step of generating correction information including position information indicating a projection area of the projected image in the combined coordinate system; and
a step of generating the projected image based on the correction information.

11. The image adjustment method according to claim 10, wherein the step of generating the correction information includes:
converting coordinates indicating the position information in the combined coordinate system into coordinates in the first coordinate system and the second coordinate system; and
converting the coordinates in the first coordinate system and the second coordinate system into coordinates in a projector coordinate system of an image projection device that projects the projected image.

12. The image adjustment method according to claim 10, wherein the step of converting the first coordinate system and the second coordinate system includes generating a composite image of the first image and the second image, based on the overlapping region.

13. An image adjustment device that generates a projected image that is to be projected onto a projection target by an image projection device, the image adjustment device comprising:
an image acquisition unit that acquires a first image by capturing an image of a first region including a part of the projected image and a second image by capturing an image of a second region including another part of the projected image, the second region including an overlapping region in which the first region and the second region overlap;
a coordinate converter that converts a first coordinate system of the first image and a second coordinate system of the second image into a combined coordinate system common to the first image and the second image;
a correction information generator that generates correction information including position information indicating a projection area of the image projection device in the combined coordinate system; and
a video generator that generates the projected image based on the correction information.

14. The image adjustment device according to claim 13, wherein the correction information generator generates the correction information by converting coordinates indicating the position information in the combined coordinate system into coordinates in the first coordinate system and the second coordinate system, and further converting the coordinates in the first coordinate system and the second coordinate system into coordinates into a projector coordinate system of the image projection device.

15. The image adjustment device according to claim 13, wherein the coordinate converter generates a composite image of the first image and the second image, based on the overlapping region.
